(19) United States
(12) Patent Application Publication
(10) Pub. No.: US 2013/0060796 A1
(43) Pub. Date: Mar. 7, 2013

(54) CONTENT AGGREGATION AND MAPPING

(71) Applicants: THOMAS J. GILG, Shedd, OR (US); Jon Brewster, Monmouth, OR (US); Dimitri Rodrigues De Souza, Porto Alegre (RS); Fernanda Dias, Porto Alegre Rio Grande Do Sul (BR)

(72) Inventors: THOMAS J. GILG, Shedd, OR (US); Jon Brewster, Monmouth, OR (US); Dimitri Rodrigues De Souza, Porto Alegre (RS); Fernanda Dias, Porto Alegre Rio Grande Do Sul (BR)

(21) Appl. No.: 13/226,569

(22) Filed: Sep. 7, 2011

(51) Int. Cl. G06F 17/30

(52) U.S. Cl. 707/756; 707/E17.005

(57) ABSTRACT

A content aggregator aggregates metadata for content from a content provider. This includes mapping the metadata from a format of the content provider to an instruction format of a fulfiller to enable the fulfiller to utilize the metadata and access the content.

### BACKGROUND

Traditional applications for handling electronic data and media such as publishing and printing applications, for example, have evolved over time. A conventional model for such applications has been optimized on large jobs where orders may exist from a single content owner crafting and providing data content according to rigid delivery and processing constraints of a single supplier. Thus, if a nominal fee of a few hundred dollars were incurred to match capabilities (e.g., data format and delivery constraints) between the owner and supplier, it generally was considered insignificant in view of the economies of scale provided by the underlying job. Given that individuals can now generate their own content and orders as opposed to larger corporations of the past, the scale for electronic jobs has now been reduced.

### BRIEF DESCRIPTION OF THE DRAWINGS

FIG. 1 illustrates an example system for content aggregation and mapping.

FIG. 2 illustrates an example of a retail service that utilizes content aggregation and mapping.

FIG. 3 illustrates an example system for routing content data by an aggregation and mapping service.

FIG. 4 illustrates an example method to facilitate content aggregation and mapping.

### DETAILED DESCRIPTION

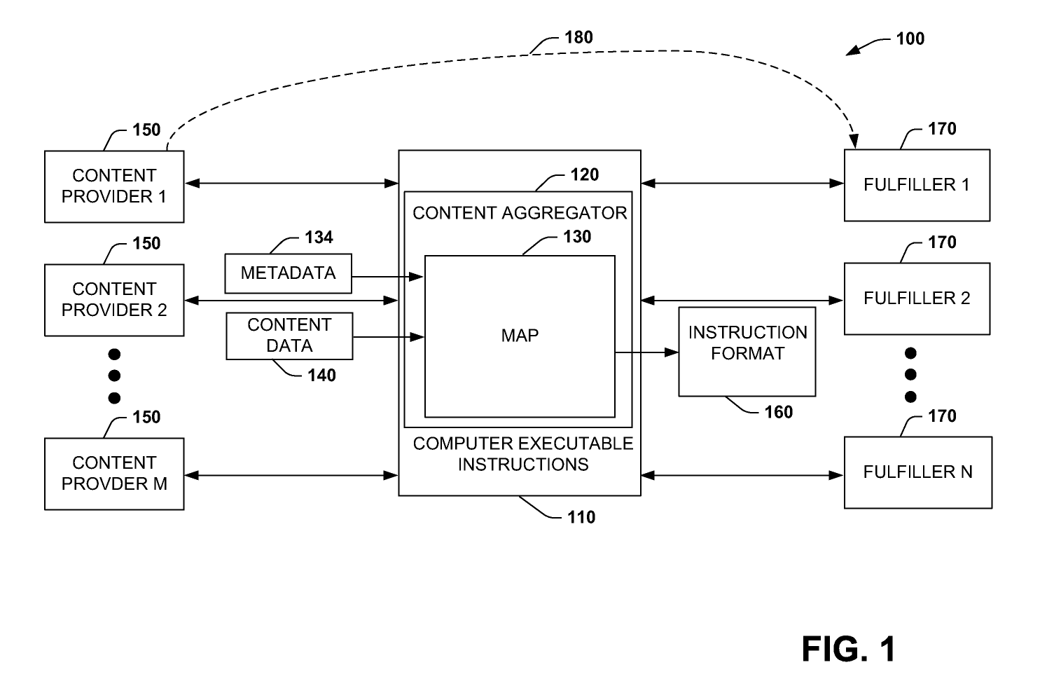

FIG. 1 illustrates an example system 100 for content aggregation and mapping. The system 100 includes computer executable instructions 110 that define a content aggregator 120 and map 130 to process metadata 134 and content data 140 from content providers 150, which are shown as providers 1-M, where M is a positive integer. The map 130 is programmed to translate between the format of the content providers 150 and an instruction format 160 utilized by fulfillers 170, which are shown as fulfillers 1-N, where N is a positive integer. In one example, the instruction format 160 includes metadata, references to content data, and/or instructions on how to utilize such metadata 134 and content data 140 by the fulfillers 170. For purposes of clarity and brevity, only a single metadata 134 and content data 140 are shown with respect to Content Provider 2 but it is to be appreciated that each of the content providers 150 can similarly generate such metadata and content data, and that the metadata and content and format there-of from each content provider can be unique. Similarly, only one instruction format 160 is shown to the fulfillers but it is to be appreciated that each of the fulfillers 170 can receive its own respective instruction format from the content aggregator 120 and map 130, and that the instruction format for each fulfiller can be unique.

As used herein, the term “fulfiller” can include entities that are directly responsible for fulfilling or processing, in whole or in part, an order based on the aggregated metadata and/or content data, per the instruction. As an example, the fulfiller 170 may be a printer who fulfills an order from a content provider 150 operating as a publishing company. In another context, the fulfiller 170 could represent an intermediate entity, such as a retailer service, which takes an electronic order from a customer and then places such order with the printer who actually fulfills the request from the retailer. Nested intermediaries can also be utilized as the fulfiller or in the chain of fulfillment. Similarly, the term “content provider” can refer to an originator or owner of the content data 140 (e.g., content author) or include a third party such as a publisher, agent or other authorized entity who has sufficient rights to reproduce or authorize reproductions of the metadata 134 and/or content data 140.

The content aggregator 120 is employed to route and/or house the metadata 134 and content data 140 to the fulfillers 170 in a substantially secure manner. The content aggregator 120 may also hide the identity of the source of the metadata or content data from the fulfillers 170. Similarly, the content aggregator 120 can hide from the content providers 150 the identity of the fulfillers 170, and details sent to those fulfillers. In an example, the metadata 134 might indicate a book title, author, its retail price, number of pages and so forth, whereas the content data 140 could include the actual content in the book (e.g., words and images). As can be appreciated, the content data 140 and metadata 134 do not have to be related to a book and can represent substantially any type of electronic data representation. The instruction format 160 can include a data format that can be executed by the fulfiller 170. In other words, the instruction format 160 is provided in a computer language/format that can be utilized by the fulfiller to execute an order. The instruction format 160 can include the content data 140, how to access such data, authorization information to place an order, and formatting of the metadata 134, for example and among other instructions (e.g., how many copies ordered, agreed upon price, shipping information, and so forth).

The map 130 can perform a many-to-many mapping (e.g., via schema, algorithm) between content providers 150 and fulfillers 170. In one example, a combination of algorithms and mappings may be employed to facilitate operations between content providers 150 and fulfillers 170. For instance, a book cover may be received having a book block (i.e., the inner part of the book) with x pages, where the cover's front, spine, and back width was assumed to wrap x pages of 50-pound paper (x representing a positive integer). If the book is sent to a fulfiller who only supports 60-pound paper, for example, an algorithm can be applied to determine if the cover will still fit, or potentially stretch/shrink the cover to fit, or reject such scenario since the cover may become too distorted.

In another example, many electronic formats supported by the content providers 150 can be converted to many different instruction formats 160 that are required by differing fulfillers 170. Other mappings are also possible including one-to-one mappings where the metadata 134 and content data 140 of the content providers 150 are determined to be in a suitable instruction format 160 and passed to the fulfillers 170 for further processing. Another mapping includes a one-to-many mapping and yet another mapping includes many-to-one mapping. The mapping can also include smaller or larger subsets of formats between providers and fulfillers. For example, a subset of three provider formats may be converted to a plurality of fulfiller formats. Another example includes a plurality of provider formats that are converted to a smaller subset of fulfiller formats (e.g., four).

It is noted that the content aggregator 120 can store both normalized and original versions of the content provider's 150 metadata, since data-loss can occur during normalization. For example, the genre categories of sports, tennis and hiking from a content provider 150 could be normalized to sports by the content aggregator 120, which may be useful for most fulfillers 170 and retailers 260. However, if a retailer can support tennis and/or hiking, using the content provider's original values instead of sports may be preferable.

It is further noted that mapping can include a complete translation from a content provider format into a fulfiller instruction format 160. The instruction format 160 can also be in a native format of the content aggregator 120 and map 130, where such native format is then employed as the instruction format. For example, the content provider 150 and fulfiller 170 may employ incompatible formats. The content provider 150 has its format converted to a native format (e.g., a generic format understood by fulfiller) of the content aggregator 120 and the native format is then employed as the instruction format 160 to the fulfiller 170. Thus, one possible format mapping example is from provider-to-fulfiller and another example format mapping includes provider-to-native format-to-fulfiller.

As noted, the metadata 134 includes data that is descriptive of the underlying content data 140. The metadata 134 can also include instructions for how the content aggregator 120 can supply the content data 140 to the aggregator 120 and/or the fulfiller 170. In one example, the content provider 150 may provide a link in the metadata 134 allowing the fulfiller 170 to directly pull the content data from the provider, such as shown as dashed arrow 180. In another example, the content provider 150 may desire to hide (e.g., obfuscate) the source of the content data 140 from the fulfillers 170. Thus, the content aggregator 120 in one example could house the content data 140 and supply it to the fulfillers 170 upon request while hiding the identity of the source from where the content data originated. In yet another example, the content aggregator 120 could act as a proxy for the content data 140. Thus, the content data 140 (and/or metadata 134) could be pulled from the content provider 150 each time such data were requested by the fulfiller 170 yet the content aggregator 120 acting as the proxy for the data would hide from where the data actually originated.

By way of further example, in a book application, a publisher might contract for a million printings under an old model where several back and forth manual exchanges were required to hash out differences between provider format and fulfiller format. As electronics have become less expensive, the number of print runs may have been reduced from hundreds of thousands from a single provider and job, to a fraction of prints (e.g., 20)—each requested from a plurality of differing providers. The content aggregator 120 may also aggregate metadata and automatically generate a catalog from a subset of available content providers 150. The resulting catalog could in turn be submitted to various fulfillers 170 for further processing such as printing in a book example.

As another example, the content aggregator 120 and map 130 can operate as an intermediary or broker between providers 150 and fulfillers 170 where confidential data sources can be protected, differing formats can automatically be mapped, and authorization for placing an order or fulfilling an order can be verified. In this manner, fulfillers 170 can be assured that entities placing orders are authorized to do so and providers 150 can be assured that their sensitive data content is handled in a secure manner by the respective content aggregator 120 acting as an intermediary between such entities.

For purposes of simplification of explanation, in the present example, different components of the system 100 are illustrated and described as performing different functions. However, one of ordinary skill in the art will understand and appreciate that the functions of the described components can be performed by different components, and the functionality of several components can be combined and executed on a single component. The components can be implemented, for example, as computer executable instructions (e.g., software, firmware), hardware (e.g., CPU, an application specific integrated circuit), or as a combination of both. In other examples, the components could be distributed among remote devices across a network, for example. The executable instructions 110 can be provided as a non-transitory computer readable medium having the computer executable instructions stored thereon.

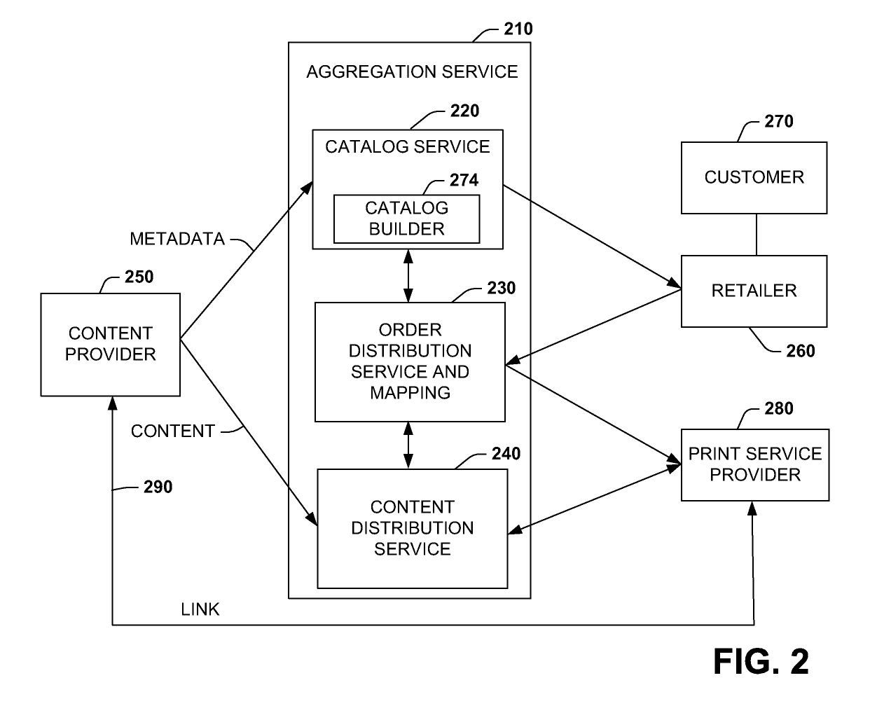

FIG. 2 illustrates an example of a retail service that utilizes content aggregation and mapping. As shown, an aggregation service 210 can include a catalog service 220, an order distribution service 230, and a content distribution service 240. A content provider 250 can submit metadata to the catalog service 220. The metadata can include descriptive elements for content, such as pricing, rights, finishing, content locations, and the like, for example. While the content provider 250 can optionally fill out an aggregation service template and associated XML metadata documents, some content providers may have their own proprietary format for communicating metadata and associated content, in which case other operations are provided by the aggregation service 210 which includes storing and mapping the proprietary format of the content provider 250 into an instruction format understood by fulfillers.

In one example, the aggregation service 210 receives and stores the content provider's metadata and format as-in in the catalog service 220, as a “3rdPartyMetadataBlock”, in order that the information is preserved as-is. The aggregation service 210 can also receive supplemental metadata from third party metadata providers, and also store them as-is as additional 3rdPartyMetadataBlocks. The format of received metadata may conform to an industry metadata standard such as ONIX XML, for example, or provided as part of an aggregator-specific protocol. The aggregation service 210 can also select and map some metadata fields from all 3rdPartyMetaBlocks into the aggregation service's 210 own native format for quicker access and processing.

In another example, fields from the native and “3rdPartyMetadataBlock” metadata are mapped via the order distribution service 230 to an instruction format for a given print service provider 280. Thus, for a given product, the native format can be employed along with one or more “3rdPartyMetadata” blocks that can be described via an XML schema for example. The schema could include such fields as third party metadata including identifier (ID) codes, provider names, time stamp information, and metadata blobs, for example. The schema can also record aggregation service 210 information such as fields that identify provider reference numbers, provider names, provider license names, administrative ID's, provider payee name, product state, and so forth. In other examples, the schema fields can include suggested retail prices, author names, sequence numbers, rights information (e.g., copyright), and fulfiller qualifications that can include qualification name and state along with related data. Other example schema fields can include fulfiller arrangements such as contracts or agreements, and information regarding the underlying content such as content state, content details, how to acquire the content (e.g., via link, direct access to aggregation service or provider), content purpose, content type (e.g., PDF or JPEG), page count, and similar fields.

As another example, the catalog service 220 can be activated to automatically construct a product catalog that can be unique for each retailer shown at 260, where customers 270 can place orders via the respective retailers and catalogs. A scheduler can be programmed to activate the catalog service at predetermined intervals (e.g., hourly or daily basis). During the catalog production process, for example, metadata can be pulled from the native area and 3rdPartyMetadata area of the aggregation service 210, where per-retailer catalog builders 274 of the catalog service 220 can automatically format catalogs into the retailer's desired format. Depending on which retailer 260 is receiving the catalog, the aggregation service 210 can selectively expose who the content providers 250 are, or alternatively, can conceal the identities of the content providers. By having a native “form” and original 3rdPartyMetadata blocks, metadata can be pulled to produce a retailer specific catalog that has minimal semantic loss. For example, a content provider may include “tennis” and “hiking” in addition to “sports” in their genre taxonomy, whereas the aggregation service might map (e.g., collapse and normalize) tennis and hiking into sports, and only store sports, in anticipation that most retailers would only support sports. However, when encountering retailers that can support tennis and/or hiking as a genre category, the aggregation service 210 can ignore its own normalized metadata and use the original content provider category values. As shown, the retailer 260 can contact the order distribution service 230 after the customer 270 places an order. The order distribution service 230 can then, in turn, contact a print service provider 280 that fulfills the order placed by the customer 270 via the retailer 260. The print service provider 280 can retrieve content data from the content distribution service 240 (e.g., directly or as a proxy) in response to the order. Alternatively, the aggregation service 210 can provide a link that enables the print service provider 280 to retrieve the content data via arrow 290 directly from the content provider 250, such as in circumstances where privacy is not of concern at the content provider.

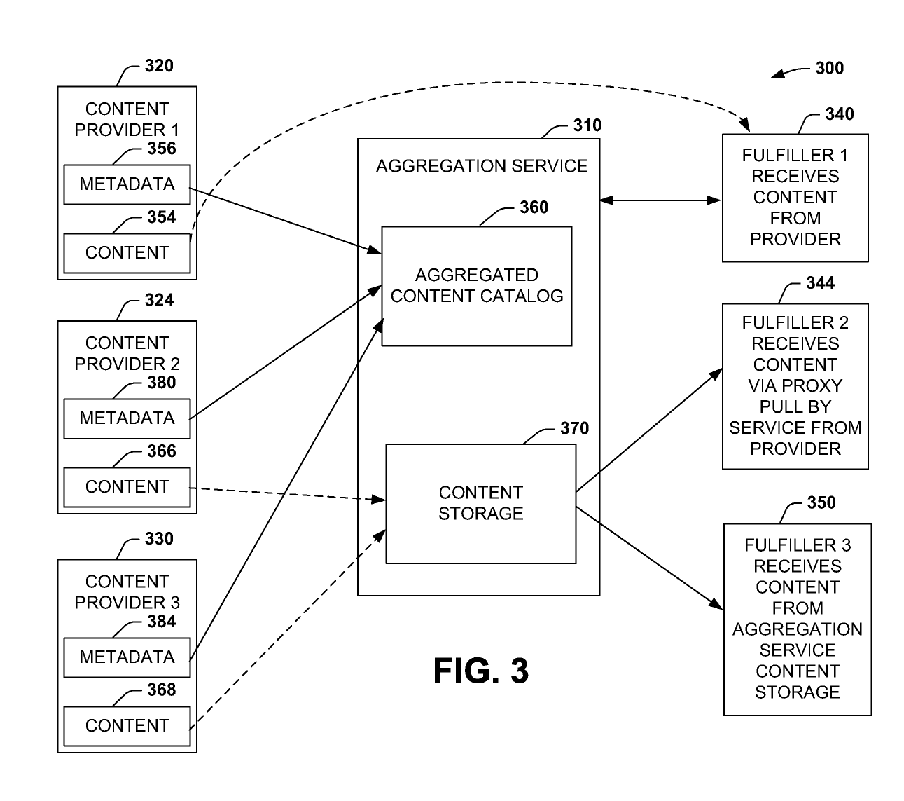

FIG. 3 illustrates an example system 300 for routing content data by an aggregation service 310. The example shown in FIG. 3 highlights a specific example of three content providers 320, 324, and 330 and three fulfillers 340, 344, and 350. As noted above with respect to FIG. 1 however, more or less providers and/or fulfillers can utilize the aggregation service 310 than the examples shown in FIG. 3.

In the example of FIG. 3, the fulfiller 340 can be authorized to observe the content's true location at the content provider as contained in the instruction format sent from the aggregation service. The fulfiller 340 can employ the location metadata to pull content 354 directly from the content provider 320. This type of arrangement can be useful when a content provider 320 has a high bandwidth content storage system, and/or desires to observe each content pull. As shown, metadata 356 from provider 320 can be stored at an aggregated content catalog 360. The fulfiller 340 in this example can gain authorization through handshakes, request metadata 360 about a specific content, and if authorized, obtain personalized content data references and metadata to enable subsequent data retrieval from the provider 320. It is noted that in the system 300, the fulfiller can be notified what the content access method is, or the fulfiller can query the aggregation service 310 and obtain the content access method from the aggregated content catalog 360. In the example system 300, the aggregated content catalog 360 is distinguished from the above description of metadata/retailer/product catalogs with respect to FIG. 2. Thus, the aggregation service's content catalog 360 can record the access method and location for each piece of content at each content provider, and record how that content can be subsequently revealed to fulfillers.

As another example, a fulfiller at 344 utilizes the aggregation service 310 as a proxy to retrieve content data. Thus, the fulfiller 344 provides an example of pulling content thru the aggregation service 310, where the aggregation service privately pulls from the content provider 324 which stores the content at 366. This feature is useful when a content provider desires that the service maintains their content and metadata storage location as hidden, and/or desires the aggregation service 310 to cache content for high-bandwidth access, and/or desires centralization.

A fulfiller 350 provides an example of pulling content 368 directly from the aggregation service 310 which stores the content 368 in a content storage 370. Providing content storage 370 at the aggregation service 310 is useful when a content provider has minimal or no online capability, and/or desires to provide a copy to the aggregation service (e.g., via portable hard drives).

The aggregated content catalog 360 can be used to store the metadata associated with each product. For example, the metadata can include a content identifier, title, description, and related content storage locations. Product metadata is often stored in a relational database, and conveyed using file formats such as XML or XLS, for example. The content storage 370 can be used to store the content associated with each product. For example, a book may consist of a cover PDF file and an interior book-block PDF file. Product content such as PDF or JPG is often stored on a NAS, SAN or file server, and conveyed using protocols such as HTTP or FTP, for example.

As noted previously, the aggregation service 310 can act as a full-time host of the content (e.g., PDF files), or let the content providers 320, 324, and 330 remain the full-time host, or aggregation service can act as a proxy to the content providers storage locations for metadata and associated content. In one example, a <content access mode> policy with the aggregation service can be configured with various flags such as: 1) “by-value from content provider”—the content can be manually conveyed from the content provider to the aggregation service ahead of time by an offline (e.g., portable hard drive) or online (e.g., FTP drop box) method, and the aggregation service can store the content; 2) “by-reference from content provider”—the aggregation service can inform the fulfiller to retrieve the content directly from the content provider, usually by an online method; 3) “by-reference from aggregation service without caching”—the fulfiller can retrieve the content from the aggregation service, at which time the aggregation service can retrieve the content from the content provider to satisfy the fulfiller's request, and the aggregation service does not permanently retain the content; and 4) “by-reference from aggregation service with caching for so many hours”—such as item (3), except the aggregation service can store the content for so many hours, or permanently, such that future orders may be able to use the aggregation service's copy instead of having to request another copy from the content provider.

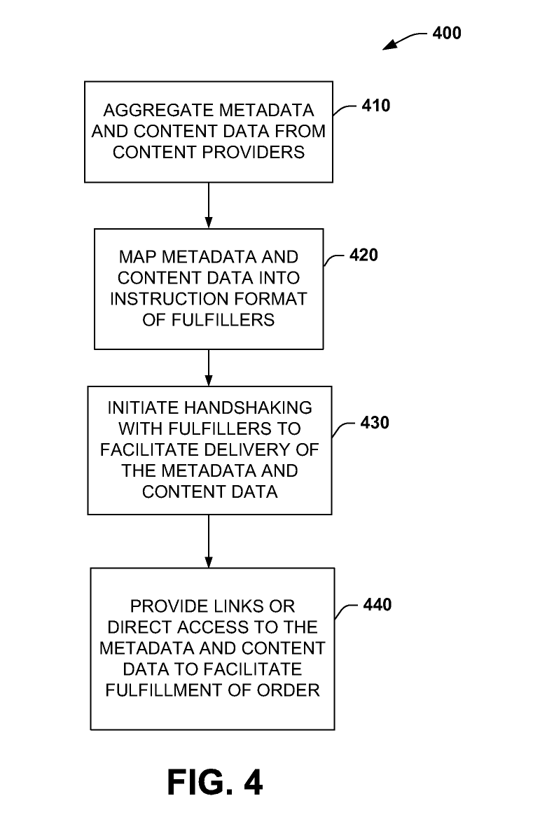

In view of the foregoing structural and functional features described above, an example method will be better appreciated with reference to FIG. 4. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by a processor and associated equipment, for example.

FIG. 4 illustrates an example method 400 to facilitate content aggregation and mapping. The method 400 includes aggregating metadata and content data from content providers at 410 (e.g., via content aggregator 120 of FIG. 1). This can include local storage of such data or storing address links to the data or a combination storage and links. The method 400 includes mapping the metadata and the content data into an instruction format of an aggregation service at 420 (e.g., via map 130 of FIG. 1). The instruction format can include data patterns that are agnostic to any fulfiller's specific requirements and thus provide a generalized format in which to communicate with the fulfillers. The method 400 also includes initiating handshaking with fulfillers to facilitate delivery of the metadata and content data via the instruction format of the aggregation service at 430 (e.g., via content aggregator 120 of FIG. 1). Such handshaking can include instructions on how to access the data (e.g., by-value, by-reference from content provider or the aggregation service). The method 400 includes providing links or access to the fulfillers via the instruction format to facilitate reception of the metadata and content data by the fulfillers at 440 (e.g., via content aggregator 120 of FIG. 1). This includes generating instructions that inform the fulfiller on how to generate or process an order. Although not shown, other aspects to the method 400 can include providing metadata and content data access to the fulfillers via a proxy service or via direct connection to the aggregation service. Other aspects of the method 400 can include directing the fulfillers to the content providers to access the content data via the instruction format of the aggregation service. This can include generating a many-to-many mapping between the content providers and the fulfillers to facilitate delivery of the metadata and content data to the fulfillers.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A computer readable medium comprising computer executable instructions that when executed cause a processor to:
aggregate metadata for content from a content provider; and
map the metadata from a format of the content provider to an instruction format of a fulfiller to enable the fulfiller to utilize the metadata and access the content.

2. The computer readable medium of claim 1, wherein the metadata includes a link to the content to enable the fulfiller to access the content from a source of the content.

3. The computer readable medium of claim 1, further comprising computer executable instructions that when executed cause a processor to store the metadata and content at a storage location of an aggregation service, the fulfiller accessing the metadata and content via the aggregation service.

4. The computer readable medium of claim 3, wherein the aggregation service operates as a proxy for the content provider by pulling the metadata and content from the content provider.

5. The computer readable medium of claim 4, wherein the fulfiller is enabled to access the content provider directly based in part on the instruction format.

6. The computer readable medium of claim 1, further comprising computer executable instructions that when executed cause a processor to automatically generate a catalog based on aggregated metadata and content from the content provider.

7. The computer readable medium of claim 6, further comprising computer executable instructions that when executed cause a processor to map between a content provider format and a native format of an aggregation service that is compatible with the fulfiller.

8. The computer readable medium of claim 7, further comprising computer executable instructions that when executed cause a processor to store links, metadata, or content from the content provider and to enable access to the metadata and content by the fulfiller.

9. The computer readable medium of claim 7, further comprising utilizing an intermediary agent to interact with the aggregation service and enable the fulfiller to access the metadata and content.

10. The computer readable medium of claim 1, wherein the map is operative to map metadata and content of differing formats from a plurality of content providers to alternative formats that are compatible with a plurality of respective fulfillers.

11. A method, comprising:
aggregating, by a processor, metadata and content data from content providers;
mapping, by the processor, the metadata and the content data into an instruction format of an aggregation service;
initiating, by the processor, handshaking with a fulfiller to facilitate delivery of the metadata via the instruction format; and
providing, by the processor, links or access to the fulfillers via the instruction format to facilitate reception of the metadata and content data by the fulfillers.

12. The method of claim 11, further comprising providing metadata and content data access to the fulfillers via a proxy service or via direct connection to the aggregation service.

13. The method of claim 12, further comprising directing the fulfillers to the content providers to access the content data via the instruction format of the aggregation service.

14. The method of claim 11, further comprising mapping metadata and content from a plurality of content providers to instruction format corresponding to a plurality of fulfillers to facilitate delivery of the metadata and content data to the fulfillers.

15. A service comprising:
a memory for storing computer executable instructions; and
a processing unit for accessing the memory and executing the computer executable instructions, the computer executable instructions comprising:
a content aggregator to collect metadata and content from a plurality of content providers;
a catalog service to generate a catalog based in part on the metadata supplied from the plurality of content providers;
an order distribution service to generate a mapping of the metadata and content to an instruction format associated with the content aggregator to supply alternative formats associated with a plurality of fulfillers; and
a content distribution service to facilitate access to the metadata and content between the plurality of content providers and the plurality of fulfillers based on the mapping.
